(19) United States
(12) Patent Application Publication
(10) Pub. No.: US 2008/0258719 A1
(43) Pub. Date: Oct. 23, 2008

(54) APPARATUS AND METHODS FOR FERROMAGNETIC WALL INSPECTION OF TUBULARS

(75) Inventors: Philip T. Putman, Houston, TX (US); William T. Walters, LaMarque, TX (US); Danny J. Uselton, The Woodlands, TX (US)

Correspondence Address: The Wendt Firm, P.C., 34 Driftoak Circle, The Woodlands, TX, 77381, US

(73) Assignees: The University of Houston, Houston, TX (US); Scan Systems, Corp, The Woodlands, TX (US)

(21) Appl. No.: 11/737,110

(22) Filed: Apr. 18, 2007

(51) Int. Cl. G01N 27/82

(52) U.S. Cl. 324/240

(57) ABSTRACT

Apparatus and methods for magnetic wall inspecting materials such as cylindrical and tubular members are disclosed. One apparatus includes a main magnetic coil producing lines of magnetic flux able to traverse a section of a tubular member in a direction generally parallel to a longitudinal axis of the tubular member; and one or more magnetic focusing members positioned along the tubular and able to redirect certain flux lines so that they are more parallel to the tubular. This abstract allows a searcher or other reader to quickly ascertain the subject matter of the disclosure. It will not be used to interpret or limit the scope or meaning of the claims. 37 CFR 1.72(b).

### FIELD OF THE INVENTION

1. Field of Invention

The present invention relates generally to the field of magnetic inspection, and more specifically to apparatus and methods of using same for magnetic wall inspection of materials such as cylindrical and tubular members. The invention was the result of a written joint research agreement (as defined in 35 USC 103(c)) entered into between the University of Houston and Scan Systems Corporation for the performance of experimental, developmental, and/or research work in the field of the claimed inventions.

2. Related Art

Inspection of metal pipe or solid tubular members by magnetic means conventionally involves magnetizing the member to create a magnetic field which extends circumferentially and is characterized by lines of magnetic flux which extend either axially of the tubular member or generally perpendicular to its axis, dependent on the manner by which magnetism is induced. In many of the present systems, current flow through a wire coil positioned about the tubular member forms magnetic lines of flux through the opening of the coil which extend axially of the member under inspection. In other systems, current flows axially of the tubular member within the wall thereof so as to create a magnetic field, the lines of flux of which extend circumferentially about the tubular member in an orientation substantially perpendicular to the tubular member. The presence of structural flaws or anomalies in the wall of the tubular member, such as surface nicks or pits, cracks, voids, or various crystalline discontinuities, disturbs the uniformity of a magnetic field in the wall of the tubular member. Accordingly, the structural integrity of the tubular member and its relative freedom of such flaws may be inspected by sensing and detecting the magnetic field variations with sensors disposed on or closely adjacent the surface of the tubular member.

Magnetic wall inspection of tubular members for structural flaws (which includes reduced wall thickness) requires that one or more inspection sensors be moved along the surface in a predetermined inspection path. In one widely used pipe magnetic wall inspection apparatus, a plurality of sensor shoes are applied to the surface of the tubular member (or just above the surface) in circumferential spacing thereabout and each of the sensor shoes is moved relatively to the tubular in a circumferential helical path whereby the plurality of sensors provides 100 percent coverage of the pipe surface. The relative movement may be effected by moving the sensors longitudinally while rotating the sensor shoes around a stationary tubular, or the tubular can be moved longitudinally while the sensors are rotated about the tubular member.

Magnetic wall inspection of regions of a tubular member is relatively straightforward and has been practiced for years, as illustrated schematically in FIG. 1, where a pipe or tube 2 moves relative to a main magnetized coil 4. Magnetic field lines 6 are able to easily find there way through the tubular wall generally parallel to the longitudinal axis of the tubular member, allowing little flux leakage (except in case a flaw is present) as depicted in the graph 8 of FIG. 2, which depicts a plot of magnetic flux Bₒ versus distance “X” along the tubular. However, the method has been unacceptable for many in the field due to “blooming” of the magnetic field lines of flux as the inspection nears an end area 10 of a tubular is approached. As illustrated in FIG. 3, the magnetic lines of flux 6 have both a vertical and a horizontal component as the end of the tubular is approached, and the vertical component becomes more pronounced as the end of the tubular is approached. Although the value or magnitude of the total flux remains the same, there is a reduction in the voltage output of the sensor since it is able to sense only the horizontal component of the flux. This reduction in sensor voltage is illustrated in FIG. 4 at 8a. With certain adjustments, plot 8b may be achieved, but plot 8c or even better is desired. Viewed from the perspective of sensor output signal (Eₒ), such as a Hall sensor, the currently known techniques can only produce a curve as depicted as curve B in FIG. 9, where the vertical lines indicate the ends of the tubular being inspected. As may be seen, curve B of FIG. 9 is unstable as much as 4 feet (122 cm) from the ends of the tubular. In this 4 feet (122 cm) of the tubular it is currently impossible to accurately measure an anomaly in the magnetic field indicative of a defect (flaw, reduced wall thickness, and the like) in the tubular. What is desired is curve A, where the Eₒ signal becomes stabile very quickly, within 12-18 inches (30-45 cm) of the end of the tubular. As the ends of a tubular are approached, it is traditional to use special end area inspection, which typically comprises utilizing high pressure washers for cleaning up to 24 inches of linear tubular surfaces. Longitudinal and transverse magnetic fields are then used to magnetize the tubular and a wet magnetic particle solution is dispersed across the inside and outside surfaces. Flaws are then visually identified and investigated using probe grinding and/or ultrasonic probes. All of this is expensive and time consuming.

The use of a yoke as part of a magnetic generator with wire coils is discussed in U.S. Pat. No. 4,058,762, wherein electrical current (alternating, direct or either), passed through the yoke induces a magnetic field, responsive to the current, in a test material connected across the end portions of the yoke. Such a yoke has been used to inspect welds, for example, in tubular members and flat plates. The use of a yoke or other magnetic flux focusing element is not known or suggested for focusing, directing, or redirecting magnetic lines of flux back into a tubular that otherwise would not “find” the tubular, either near the end of a tubular or remote from the tubular ends.

There is a long but as yet unmet need in the magnetic wall inspection of tubulars art for effective apparatus and methods for focusing and/or redirecting magnetic lines of flux so that they are more parallel to the tubular being inspected (or reducing the blooming effect) for more efficient flaw detection, including reduced wall thickness, in tubulars.

### SUMMARY OF THE INVENTION

In accordance with the present invention, apparatus and methods are described that reduce or overcome problems in previously known apparatus and methods for magnetic wall inspection of tubulars.

One aspect of the present invention are apparatus for magnetic wall inspection of tubulars for flaws, one apparatus comprising:
a) a main magnetic coil producing lines of magnetic flux able to traverse a section of a tubular member in a direction generally parallel to a longitudinal axis of the tubular member;
b) one or more magnetic focusing members able to redirect certain ones of the flux lines so that they are more parallel to the tubular; and
c) one or more magnetic flux sensors for sensing anomalies in the magnetic lines of flux caused by flaws in the tubular member (wherein by “flaw” we mean defects including reduced wall thickness).

Apparatus within the invention may include one or more frames for supporting the main coil, focusing member or members, and magnetic flux sensors. In certain embodiments, the main coil, focusing members may be separately supported by their own frames. The one or more magnetic focusing members may be selected from focusing magnetic coils, a metallic yoke, or combinations of these. A focusing coil, if used, may be positioned upstream of the main coil, downstream of the main coil, and both upstream and downstream of the main coil. A yoke, if used, may be positioned so that a first potion of the yoke is positioned upstream of the main coil and generally perpendicular to the tubular longitudinal axis, and a second portion is positioned downstream of the main coil and generally perpendicular to the tubular longitudinal axis, with a connector piece connecting the first and second portions and generally parallel to the tubular longitudinal axis. Certain embodiments may include both a yoke and one or more focusing coils, wherein the focusing coils may be positioned on either side of the first and second portions of the yoke. These embodiments are further described herein.

Another aspect of the invention are methods for magnetic wall inspection of tubular members, in general comprising:
a) providing relative movement between a tubular member and an apparatus comprising a main magnetic coil, the magnetic coil setting up a magnetic field in the tubular member;
b) providing one or more magnetic focusing members positioned along the tubular member;
c) redirecting a portion of magnetic lines of flux from the main coil into the tubular member using the one or more focusing members; and
d) sensing variations in the magnetic field produced by flaws in the tubular member.

Methods of the invention include sliding one or more magnetic sensors on or a certain distance above the tubular member. In certain methods of the invention, the sensing includes adjusting the distance of a bottom surface of the sensor elements from the tubular member during sensing.

Apparatus and methods of the invention may be employed by passing a tubular member through a stationary inspection station including one or more apparatus of the invention, or apparatus of the invention may be moved along a stationary tubular member. Indeed, both the tubular member and apparatus of the invention may move, as long as there is relative movement between them effective to perform the inspection.

Apparatus and methods of the invention will become more apparent upon review of the brief description of the drawings, the detailed description of the invention, and the claims that follow.

### BRIEF DESCRIPTION OF THE DRAWINGS

The manner in which the objectives of the invention and other desirable characteristics can be obtained is explained in the following description and attached drawings in which:

FIGS. 1 and 3 are schematic cross-sectional views of a prior art apparatus;

FIGS. 2 and 4 are graphs of magnetic flux (B) versus distance along a tubular member in accordance with the apparatus of FIGS. 1 and 3, respectively;

FIGS. 5-8 are schematic cross-sectional views of four apparatus embodiments in accordance with the invention; and

FIG. 9 compares Hall effect sensor outputs when employing a prior art magnetic wall inspection apparatus with an apparatus of the invention.

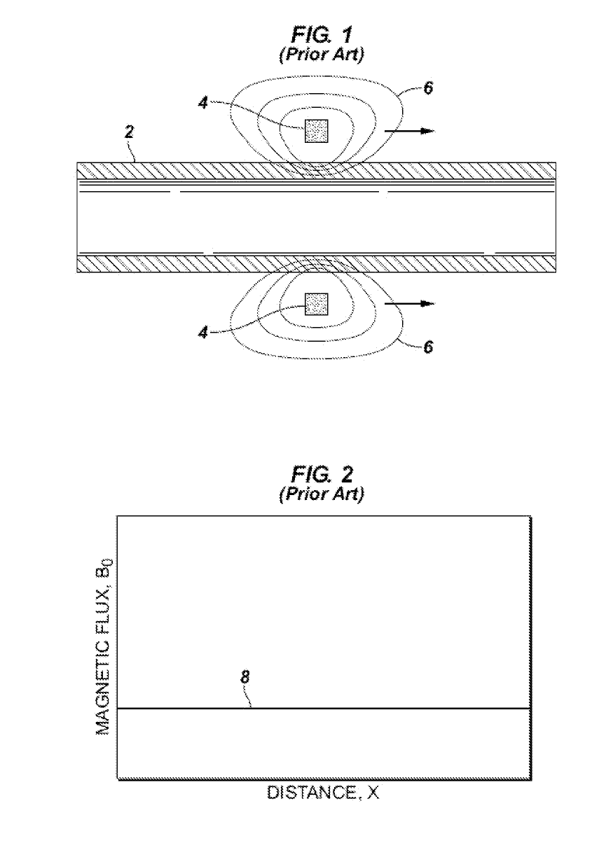

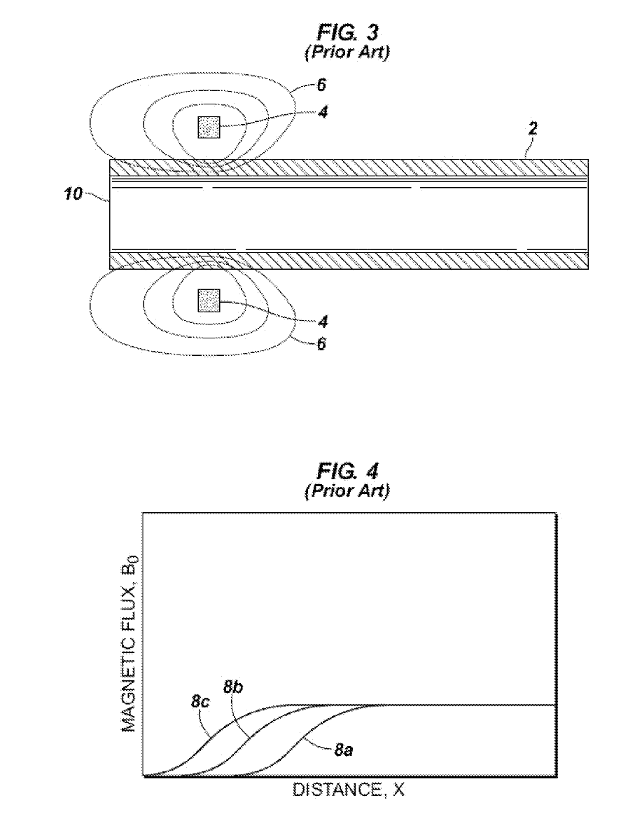

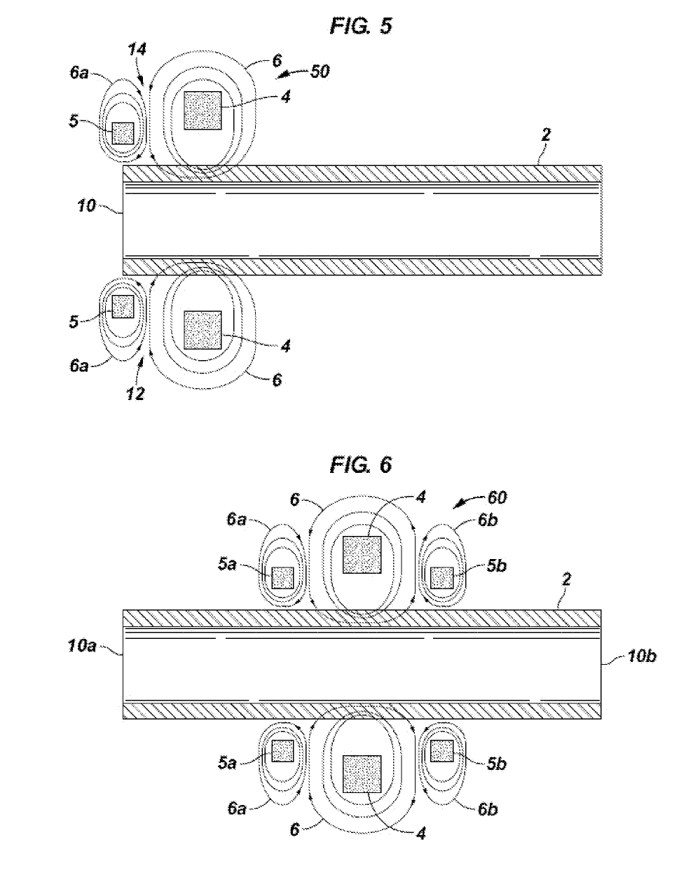

It is to be noted, however, that FIGS. 1, 3, and 5-8 are not necessarily to scale and that FIGS. 5-8 illustrate only typical embodiments of this invention, and are therefore not to be considered limiting of its scope, for the invention may admit to other equally effective embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romantic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

The present invention is directed toward solving or alleviating problems in magnetic wall inspection of tubular members, in particular pipe, tubing, sucker rods, and the like used in the petroleum production and petrochemical industries, using magnetic coils. One problem frequently encountered in magnetic wall inspection of these materials for flaws, such as reduced wall thickness and other defects, is that as explained previously in reference to FIGS. 1-4 and 9, as the ends of the tubular are approached, the magnetic flux lines develop more vertical component. As the sensors can only sense the horizontal component of the magnetic flux, the voltage output of the sensors is reduced as the ends of the tubular are approached. This problem with magnetic flux-based flaw detection has been so difficult to solve that it has largely been accepted by the non-destructive testing community as unsolvable. In fact, artisans have developed other means for 100 percent inspection, such as ultrasonic inspection, as discussed in U.S. Pat. No. 6,945,113.

Apparatus and methods of the invention address these problems by providing a main magnetizing coil and one or more magnetic focusing elements that allow improved magnetic flux inspection of tubular members. The focusing elements may also be termed “redirecting elements.”

Apparatus of the invention may be incorporated into larger units, within pipe plants, as well as into well head inspection equipment.

Referring now to the figures, which are not necessarily to scale, FIG. 5 illustrates schematically a cross-section view of one apparatus embodiment 50 within the invention. (The same numerals are used throughout the drawing figures for the same parts unless otherwise indicated.) Illustrated in FIG. 5 is a pipe or other tubular member 2 over which is traversing a main coil 4 and a focusing coil 5. Magnetic flux sensors are not illustrated for clarity, but may either slide along the tubular, or just above the surface of the tubular. Also for clarity, a frame for supporting the main coil and focusing coil is not illustrated. Magnetic flux sensors and support frames are well known in the art and the skilled artisan would have little difficulty constructing and using each. As such, no further discussion is deemed necessary of these features.

As indicated in FIG. 5, lines of magnetic flux 6 from main coil 4 generally find the tubular member 2 during magnetic wall inspection, however, some of the magnetic lines of flux, such as the outer-most magnetic lines, may stray away from the tubular. This is illustrated in FIG. 5 near an end 10 of tubular 2, but this phenomenon may also occur remote from the ends of tubulars, so apparatus and methods of the invention are not limited to inspection of ends of tubulars. In embodiment 50 of FIG. 5, focusing coil 5 supplies auxiliary lines of magnetic flux 6a, and since lines of magnetic flux do not cross, auxiliary lines of magnetic flux 6a serve to push, steer, focus, direct or re-direct magnetic flux lines 6 in the areas 12, 14, so that they become more parallel to the tubular being inspected, and be useful in detecting flaws in the tubular.

FIG. 6 illustrates an apparatus embodiment 60 similar to embodiment 50 of FIG. 5, the only difference being the inclusion of two focusing coils 5a, 5b, one being upstream of main coil 4, one being downstream of main coil 4.

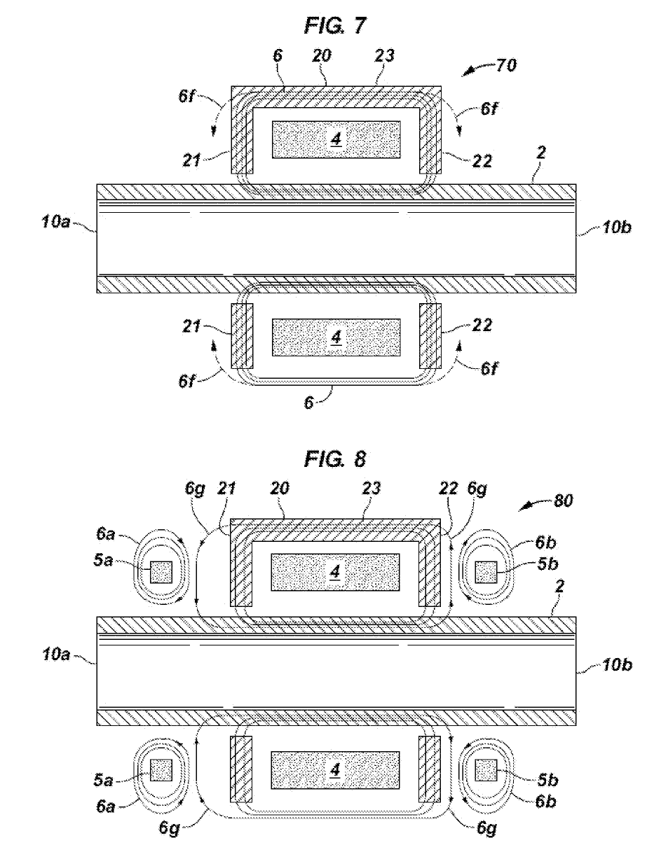

FIG. 7 illustrates an embodiment 70 within the invention wherein the focusing member is a yoke 20 having two portions 21, 22, generally perpendicular to tubular member 2, and a connecting portion 23 generally parallel to the longitudinal axis of the tubular 2. Yoke portions 21, 22 serve to focus, direct, re-direct or steer magnetic lines of flux 6f so that they are more parallel to tubular 2.

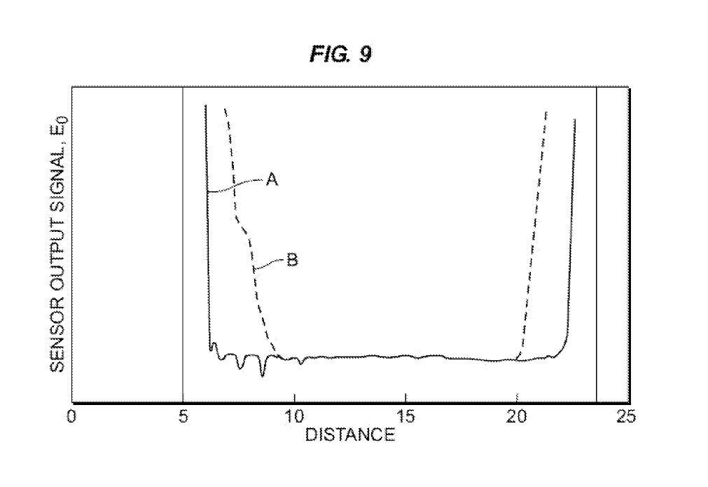

FIG. 8 illustrates an embodiment 80 within the invention which is essentially a combination of embodiments 60 and 70. Magnetic lines of flux 6g that otherwise would not be as parallel to tubular 2 are directed by a combination of “pushing” by fields 6a, 6b from focusing coils 5a, 5b, respectively, and “pulling” by yoke portions 21, 22. With this embodiment, the entire tubular, including up to about 12-18 inches (30-45 cm) from each end 10a, 10b of the tubular 2 may be inspected using magnetic wall inspection. The curve A in FIG. 9 exemplifies the result of using a yoke and focusing coils in conjunction with a main magnetic coil. Curve A normalizes, or becomes stable, much more quickly than Curve B which illustrates a result when not using a yoke and focusing coils. It is theorized that by employing a different design of yoke (for example a thicker yoke or longer yoke) it may be possible to eliminate the need for focusing coils, and inspect even closer to the ends of the tubular than the above-mentioned 12-18 inches (30-45 cm).

The main and focus magnetic coils may have any turns of wire and resistance as are commonly used in magnetic flux leakage flaw detection equipment, for example, 1000 to 3000 turns of copper wire having a resistance ranging from 2 to 6 ohms at 20° C. The focus coils may comprise more or less turns of wire than the main coil, and may be the same or different wire in terms of composition, resistance, diameter, and the like.

Sensor elements useful in the invention may be selected from Hall elements, magneto diodes and magneto resistors, all of which are well known in the art and require no further explanation. The sensors may be carried by any number a sensor shoe designs known in the art. One type of sensor shoe comprises a top surface and a curved bottom surface designed to generally follow contours of the tubular being inspected. A four-sided, generally rectangular surface defines a slot for holding a sensor element. Set screws may be used to lock or set a sensor element in place in the sensor shoe. Other screws may be used to secure the sensor shoe to a primary support member. Skids pads may be used for sensors that slidingly engage the surface of the tubular being inspected. Skid pads are not required in embodiments where the sensors do not touch the surface of the tubular, as mentioned further herein. Sensors, sensor shoes, skid pads (where used), and support members may be components of a detector assembly, including a frame in which support arm assemblies and their corresponding actuators may be mounted. The sensors may be arranged in the assembly to allow the sensor elements to monitor magnetic field variations without gaps between sensors during an inspection procedure, therefore providing a minimum of 100 percent coverage of any tubular member being inspected. The number of support arm assemblies and their respective sensor elements and skid pads may range from two up to the number required to make a complete inspection. Alternatively, fewer support arm assemblies could be used if the tubular member is able to be passed through apparatus of the invention more than once.

Skid pads (when used) may be constructed of a body portion comprising metal, such as brass, carbon steel, stainless steel, and the like, while the surface of the skid pad that actually skids along the workpiece may be being a hard, wear-resistant material, such as a metal such as titanium, titanium steel alloys, and the like, a ceramic such as silicon carbide, titanium carbide, and the like or a natural or synthetic material such as a diamond-like carbon coating. Alternatively, in certain embodiments substantially all of the skid pad (body and skid surface) may be comprised of a hard, wear-resistant material. In embodiments wherein the skid pad comprises a body and a skid pad layer or coating that actually engages the workpiece, the skid pad layer or coating may have any thickness, but may be 0.040 inch (1 mm) or higher. Thicker skid pad contact surfaces may have longer life between changes or failures, but may be more expensive initially.

Sensor holders may be comprised of any materials, but they may be lighter than the skid pad materials. Useable materials for the sensor holder include metals such as aluminum, nickel, copper, and brass; thermoplastic materials such as polytetrafluoroethylene, polycarbonate, polyolefins such as polyethylene and polypropylene, and the like, and thermosetting plastics, such as phenol formaldehyde resins, and the like. Thermoplastic elastomers may be used. If the sensor holder is plastic, optional fillers, toughening agents, processing aids, pigments, and the like may be present. Combinations of these materials may be used, such as plastic coated metals, and metal-coated plastics. In any case, the sensor holder should allow the sensor element bottom surface to be able to be adjusted to be very close to the work piece, such as 0.001 inch (0.025 mm), although larger gaps, such as 0.010 inch (0.25 mm) or more may be sufficient, depending on the size of the feature to be detected. For example, smaller gaps will allow smaller cracks to be detected.

A dual linkage detector arm support assembly may facilitate positioning of the sensor elements on a substantially parallel axis to the tubular member. Currently known apparatus use a single pivot point which does not allow the detectors to be positioned in a precise manner. They are consistently at odd angles and off axis to the center of the tubular member. In certain sensor assemblies useful in the invention, an optional feature is the provision of one or more substantially frictionless members, which may be two roller bearings, for each detector support arm, to help maintain a precise air gap between the sensing element bottom surface and the tubular member surface. Use of this feature is described in assignee's co-pending patent application Ser. No. 11/191,843, filed Jul. 28, 2005, incorporated by reference herein. The substantially frictionless members may benefit users of the inventive apparatus in one or more of the following ways: reduced wear of the magnetic sensor elements, which can save the user time and money; reduced (and in some cases, totally overcome) magnetic noise from the surface of the tubular member; and signal to noise relationships that allow digital electronics to produce better signal processing. The precise air gap means reduced noise from the tubular member surface, and the quality of signals may be completely independent of inspection speed. Digital signal processing software, known under the trade designation Digi-Pro™, available from Scan Systems Corp, Houston, Tex., allows 100 percent of the inspection signal to be digitized and processed within a computer. The computer and digital signal processing software known under the trade designation Digi-Pro™ may utilize a series of virtual printed circuit boards known under the trade designation SimKardz™ to perform the calculations required. Signals may be captured from the sensor elements and digitized almost immediately, then processed through one or more algorithms to produce large signal to noise ratios. Improvements in signal to noise ratios of at least 20 percent, sometimes at least 100 percent, and in certain embodiments even 200 percent have been seen, compared with existing industry standard equipment.

Inspection assemblies may be powered through pressurized fluids, such as compressed air, nitrogen, argon, and the like, including synthetic air such instrument air (air having most if its moisture removed), and hydraulic fluid systems. Depending on availability and/or the type of actuator assembly actually used in detecting the wide region of the tubular member being inspected, apparatus of the invention may also be powered by battery, fuel cell, or other local power source. Certain embodiments may use only one or more solenoids to operate an actuator assembly.

One or more motors may be used that produce a linear stroke to move the primary support arms away from the secondary support arms. If motors are employed, an oil lubrication system may be used to protect and lubricate the motor, gears, and other mechanical parts. Alternatively, these parts may be comprised of frictionless coatings.

Apparatus and method embodiments of the invention may employ pneumatic pressure, hydraulic pressure, motors or solenoids to operate the apparatus. Any component or collection of components that function to allow selectively opening and closing the detector assemblies may be employed.

Typical uses of apparatus and methods of the invention for magnetic wall inspection will be in situations when it is desired to inspect tubing, pipe, or sucker rods in situ, as they are removed from a well bore. Alternatively, apparatus and methods of the invention may be used to inspect tubular members that are still in the warehouse, or which have been returned to a warehouse for inspection.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, no clauses are intended to be in the means-plus-function format allowed by 35 U.S.C. §112, paragraph 6 unless “means for” is explicitly recited together with an associated function. “Means for” clauses are intended to cover the structures described herein as performing the recited function and not only structural equivalents, but also equivalent structures.

What is claimed is:

1. An apparatus comprising:
a) a main magnetic coil producing lines of magnetic flux able to traverse a section of a tubular member in a direction generally parallel to a longitudinal axis of the tubular member;
b) one or more magnetic focusing members able to redirect certain ones of the flux lines so that they are more parallel to the tubular; and
c) one or more magnetic flux sensors for sensing anomalies in the magnetic lines of flux caused by flaws in the tubular member.

2. The apparatus of claim 1 comprising a frame for supporting the main coil and the one or more magnetic focusing members.

3. The apparatus of claim 1 wherein the main coil and the one or more focusing members are separately supported by their own frames.

4. The apparatus of claim 1 wherein the one or more magnetic focusing members is selected from focusing magnetic coils, a metallic yoke, and combinations of these.

5. The apparatus of claim 1 wherein the one or more magnetic focusing coil is selected from a single magnetic focusing coil positioned upstream of the main coil, a single magnetic focusing coil positioned downstream of the main coil, and combinations thereof.

6. The apparatus of claim 4 wherein the one or more magnetic focusing members is a yoke positioned so that a first potion of the yoke is positioned upstream of the main coil and generally perpendicular to the tubular longitudinal axis, and a second portion is positioned downstream of the main coil and generally perpendicular to the tubular longitudinal axis, with a connector piece connecting the first and second portions and generally parallel to the tubular longitudinal axis.

7. The apparatus of claim 6 comprising a first magnetic focusing coil positioned near the first portion of the yoke.

8. The apparatus of claim 7 comprising a second magnetic focusing coil positioned near the second portion of the yoke.

9. An apparatus for magnetic flux leakage inspection of tubular members, comprising:
a) a frame;
b) the frame supporting a main magnetic coil, the main magnetic coil producing lines of magnetic flux able to traverse a section of a tubular member in a direction generally parallel to a longitudinal axis of the tubular member;
c) one or more magnetic focusing members able to redirect certain ones of the flux lines so that they are more parallel to the tubular member, the magnetic focusing members selected from focusing magnetic coils, a metallic yoke, and combinations of these; and
d) one or more magnetic flux sensors for sensing anomalies in the magnetic lines of flux caused by flaws in the tubular member.

10. The apparatus of claim 9 wherein the one or more magnetic focusing members is selected from a single magnetic focusing coil positioned upstream of the main coil, a single magnetic focusing coil positioned downstream of the main coil, and combinations thereof.

11. The apparatus of claim 9 wherein the one or more magnetic focusing members is a yoke positioned so that a first potion of the yoke is positioned upstream of the main coil and generally perpendicular to the tubular longitudinal axis, and a second portion is positioned downstream of the main coil and generally perpendicular to the tubular longitudinal axis, with a connector piece connecting the first and second portions and generally parallel to the tubular longitudinal axis.

12. The apparatus of claim 11 comprising a first magnetic focusing coil positioned near the first portion of the yoke.

13. The apparatus of claim 12 comprising a second magnetic focusing coil positioned near the second portion of the yoke.

14. A method comprising:
a) providing relative movement between a tubular member and an apparatus comprising a main magnetic coil, the magnetic coil setting up a magnetic field in the tubular member;
b) providing one or more magnetic focusing members positioned along the tubular member;
c) redirecting a portion of magnetic lines of flux from the main coil into the tubular member using the one or more focusing members; and
d) sensing variations in the magnetic field produced by defects in the tubular member.

15. The method of claim 14 wherein the providing one or more magnetic focusing members positioned along the tubular member comprises providing a first magnetic focusing coil upstream of the main coil.

16. The method of claim 15 comprising providing a second magnetic focusing coil downstream of the main coil.

17. The method of claim 14 wherein the providing one or more magnetic focusing members positioned along the tubular member comprises positioning a yoke so that a first potion of the yoke is positioned upstream of the main coil and generally perpendicular to a longitudinal axis of the tubular member, and a second portion is positioned downstream of the main coil and generally perpendicular to the longitudinal axis of the tubular member, with a connector piece connecting the first and second portions and generally parallel to the longitudinal axis of the tubular member.

18. The method of claim 17 comprising positioning a first magnetic focusing coil near the first portion of the yoke.

19. The method of claim 18 comprising positioning a second magnetic focusing coil near the second portion of the yoke.

20. The method of claim 14 wherein the directing stray magnetic flux from the main coil into the tubular member comprises pulling a portion of the stray magnetic flux using a yoke, and pushing remaining stray magnetic flux using one or more focusing coils.
